(19) United States
(12) Patent Application Publication
(10) Pub. No.: US 2008/0136843 A1
(43) Pub. Date: Jun. 12, 2008

(54) Display device and back light thereof and method of driving the back light

(75) Inventors: Li-Yung Lu, Taipei (TW); Kui-Hao Chang, Taipei (TW); Yen-Yi Li, Taipei (TW)

Correspondence Address: BACON & THOMAS, PLLC, 625 SLATERS LANE, FOURTH FLOOR, ALEXANDRIA, VA, 22314, US

(73) Assignee: Tatung Company, Taipei (TW)

(21) Appl. No.: 11/797,782

(22) Filed: May 8, 2007

(30) Foreign Application Priority Data
Dec. 12, 2006 (TW) 095146469

(51) Int. Cl. G09G 5/10

(52) U.S. Cl. 345/690; 977/742

(57) ABSTRACT

A display device, a back light thereof, and a method of driving the back light are disclosed in the present invention. A field emitting back light plate is used as a back light module of a passive light-emitting display device in the present invention. Because various video signals are produced in different timing, the brightness of the light and the lightening region are controlled in accordance with the video signals in the timing. Hence, the power consumption of the back light in the display device is decreased. Besides, the contrast of the display device is increased, and the life-span of the back light is lengthened.

### BACKGROUND OF THE INVENTION

1. Field of the Invention

The present invention relates to a display device, a back light thereof, and a method of driving the back light, and, more particularly, to a passive light-emitting display device, a back light thereof, and a method of driving the back light.

2. Description of Related Art

Comparing to self-luminous display devices, e.g. a cathode ray tube (CRT) display device, a plasma display panel (PDP), and so forth, a liquid crystal display device (LCD) or an LCD TV is a passive light-emitting display device. The passive light-emitting display device is required to combine a liquid crystal panel with a back light. Through affecting the intensity of the light emitting from the panel, which is controlled by the liquid crystal, a picture is displayed.

Currently, a cold cathode fluorescent lamp (CCFL) is generally used as the back light of the LCD. However, utilizing the CCFL as the back light of the LCD is confronted with many problems, which are necessary to be solved. For example, assembling the CCFL is extremely complex, repairing the CCFL is difficult, and the surface of the CCFL has a high temperature which is detrimental to the characteristics of the liquid crystal. Hence, the brightness of the LCD can not be increased, and the power consumption of the LCD can not be decreased. In addition, because of the CCFL having mercury therein, the environment may be polluted by it when it is ultimately discarded.

If products such as a large size LCD or a large size LCD TV will be developed in the future, it is predictable that manufacturing the large area back light will accordingly be very difficult and this will cause a bottleneck in the manufacturing processes. Therefore, as the market demand is for larger and larger LCDs, there an need the development of the LCD with the characteristics of low cost, high brightness, low electrical consumption, and the light of the LCD not giving off any mercury vapor.

### SUMMARY OF THE INVENTION

The object of the present invention is to provide a back light module, which is provided with operating power by a power supply and overlaps a passive light-emitting panel. The back light module of the present invention comprises a field emitting back light plate and a back light driving unit. The field emitting back light plate comprises an anode plate, a cathode plate, and a fluorescent substance. The anode plate is located on the cathode plate, and the fluorescent substance is formed on the anode plate. Furthermore, the back light driving unit conducts to the field emitting back light plate, and receives a plurality of video signals. In accordance with the plurality of video signals, the back light driving unit controls the emission of the field emitting back light plate, so as to make at least one area of the fluorescent substance luminesce and simultaneously at least one another area of the fluorescent substance not luminesce.

Another object of the present invention is to provide a passive light-emitting display device that comprises a timing control unit, a panel, a panel driving unit, and a back light module. Moreover, the timing control unit receives a plurality of video signals. The panel displays a picture, and the panel driving unit conducts to the timing control unit and the panel. The back light module, which overlaps the panel, comprises a field emitting back light plate, and a back light driving unit. The field emitting back light plate comprises an anode plate, a cathode plate, and a fluorescent substance. The anode plate is located over the cathode plate, and the fluorescent substance is formed on the anode plate. Furthermore, the back light driving unit conducts to the timing control unit and the field emitting back light plate. In accordance with the plurality of video signals received from the timing control unit, the back light driving unit controls the emission of the field emitting back light plate, so as to make at least one area of the fluorescent substance luminesce and simultaneously at least one another area of the fluorescent substance not luminesce.

The cathode plate of the present invention can comprise a plurality of electron emitters. When the back light driving unit encloses a vacuum or close to a vacuum therein, the plurality of electron emitters are driven to emit at least one electron toward the anode plate. The electrons bombard at least one area of the fluorescent substrate on the field emitting back light plate, so as to make the area of the fluorescent substrate luminesce.

The back light driving unit of the present invention comprises at least one scanning driver and at least one data driver. The scanning driver and the data driver both conduct to the field emitting back light plate. The timing control unit transmits not only a plurality of scanning signals to a scanning driver, but also the plurality of video signals to a data driver, so as to drive the field back light plate.

The passive light-emitting display device of the present invention can further comprise a power supply. The power supply conducts to the timing control unit, the panel driving unit, the back light driving unit, and the back light module, in order to provide the operating power to them.

In the present invention, the panel is non-luminous, and is necessary to be supplied with light by the field emitting back light plate for displaying a picture. The panel of the present invention is a passive light-emitting display device panel, and is preferable to be a liquid crystal display device panel. The panel driving unit can comprise at least one gate driver and at least one source driver, which both conduct to the timing control unit and the panel.

Another object of the present invention is to provide a method for driving a back light, in order to control a back light module of a passive light-emitting display device. The method for driving a back light comprises the following steps: dividing the back light module into a plurality of areas; receiving a plurality of video signals; classifying the plurality of video signals into a plurality of groups, and each of the plurality of groups corresponding to each of the plurality of areas on the back light module; calculating an average brightness of each group of the plurality of video signals; selecting a luminescence gamma voltage corresponding to the average brightness of each group of the plurality of video signals; and driving each area of the back light module corresponding to each group of the plurality of video signals according to the luminescence gamma voltage.

In the above-mentioned method, the plurality of video signals can be input to the timing control unit, and then can also be input to the panel from the timing control unit. Besides, each area of the back light module corresponding to each group of the plurality of video signals is close to each other.

In the present invention, the mentioned luminescence gamma voltage corresponding to each group of the plurality of video signals is selected from one of plurality of predetermined values. When each luminescence gamma voltage corresponding to each of the plurality of predetermined values is used, each area of the back light module corresponding to each group of the plurality of video signals emits different light brightness.

Therefore, in the present invention, the display device, the back light thereof, and the method of driving the back light can be utilized to decrease the power consumption of the light, to lengthen the life-span of the light, and to increase the brightness and the contrast of the whole display picture.

Other objects, advantages, and novel features of the invention will become more apparent from the following detailed description when taken in conjunction with the accompanying drawings.

### BRIEF DESCRIPTION OF THE DRAWINGS

FIG. 1 is a system diagram of a passive light-emitting display device in the embodiment of the present invention;

FIG. 2 is a frame diagram of the passive light-emitting display device in the embodiment of the present invention;

FIG. 3 is a frame diagram of the back light module in the embodiment of the present invention;

FIG. 4 is a perspective view of the field emitting back light plate in the embodiment of the present invention;

FIG. 5A is a view of the emitting condition of the field emitting back light plate in the embodiment of the present invention;

FIG. 5B is a view of the emitting condition of the field emitting back light plate in the embodiment of the present invention; and,

FIG. 5C is a view of the emitting condition of the field emitting back light plate in the embodiment of the present invention.

### DETAILED DESCRIPTION OF THE PREFERRED EMBODIMENT

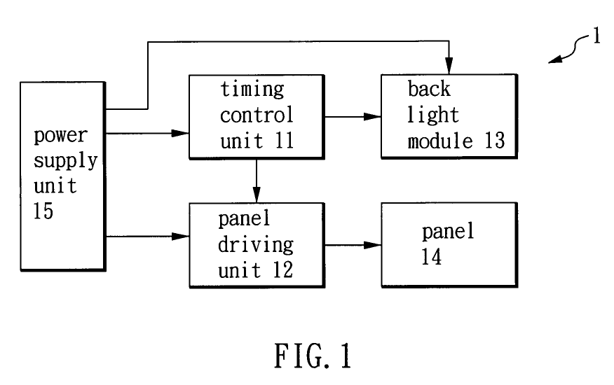

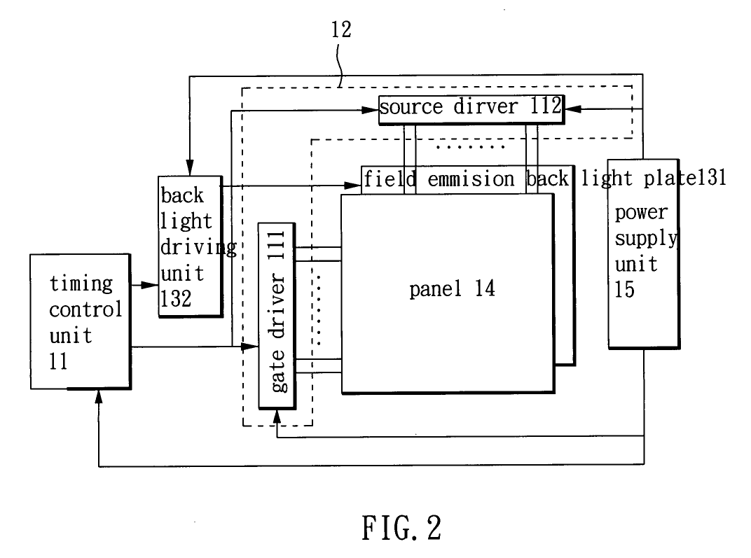

With reference to FIG. 1 and FIG. 2, FIG. 1 shows a system diagram of a passive light-emitting display device, and FIG. 2 a frame diagram of the passive light-emitting display device in the embodiment of the present invention.

As shown in FIG. 1, a passive light-emitting display device 1 comprises a timing control unit 11, a panel driving unit 12, a back light module 13, a panel 14, and a power supply unit 15.

The panel driving unit 12 conducts to the timing control unit 11 and the panel 14. The back light module 13 conducts to the timing control unit 11. The power supply unit 15 conducts to the timing control unit 11, the panel driving unit 12, and the back light module 13.

A plurality of video signals are received, then processed and operated by the aforementioned timing control unit 11. In addition, the processed and operated a plurality of video signals are output from the timing control unit 11, in order to control every unit connecting thereto.

With reference to FIG. 2, in the present embodiment, a panel driving unit 12 comprises a gate driving unit 111 and a source driving unit 112. The gate driving unit 111 and the source driving unit 112 both conduct to the timing control unit 11 and the panel 14. Besides, both of the gate driving unit 111 and the source driving unit 112 are controlled by the timing control unit 11.

The mentioned back light module 13 comprises a field emitting back light plate 131 and a back light driving unit 132. The field emitting back light plate 131 and the back light driving unit 132 are illustrated hereinafter.

In the present embodiment, the above panel 14 is a passive light-emitting panel, which does not luminesce by itself, e.g. panels of a liquid crystal display device (LCD), a liquid crystal on silicone (LCOS) display device, a non-homogeneous polymer dispersed liquid crystal display device (NPD-LCD), and so forth. This kind of passive light-emitting panel needs to be supported by a light for displaying a picture. Therefore, the panel 14 is supported by a light of the above back light module 13 so as to display a picture. Moreover, the field emitting back light plate 131 preferably overlaps the panel 14, and the light perpendicular to the back light plate 131 emitting from the back light plate 131 can travel the shortest optical distance to the panel 14.

The above power supply unit 15 is conducted with the panel driving unit 12 and the back light module 13 to supply operative power thereof.

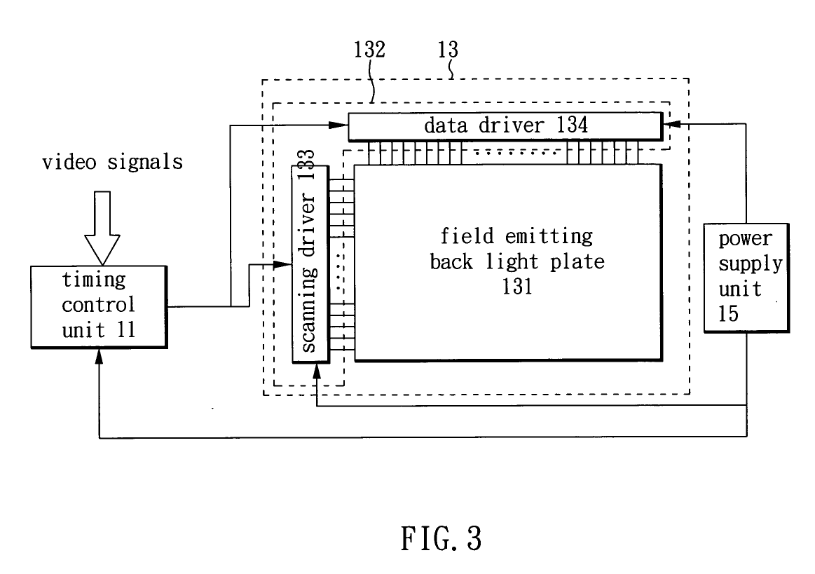

In the present embodiment, as shown in FIG. 3, there is a frame diagram of the back light module 13. The back light driving unit 132 comprises a scanning driver 133 and a data driver 134, which both conduct to the power supply unit 15, the timing control unit 11, and the field emitting back light plate 131.

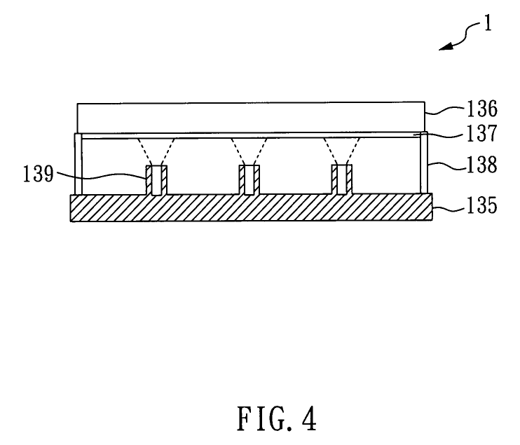

FIG. 4 shows a perspective view of the field emitting back light plate 131 in the present embodiment. As shown in FIG. 4, the field emitting back light plate 131 comprises an anode plate 136, a cathode plate 135, and a fluorescent substrate 137 coated onto the anode plate 136 and two partition plates 138.

The above-mentioned cathode plate 135 is located close to the anode plate 136 on which the fluorescent substrate 137 is coated. The cathode plate 135 further comprises a plurality of electron emitters 139. In the present embodiment, the plurality of electron emitters 139 are carbon nanotubes. The anode plate 136 and the cathode plate 135 are partitioned by the two partition plates 138 in two sides thereof. Besides, there is a vacuum between the anode plate 136 and the cathode plate 135.

After the timing control unit 11 outputs the processed a plurality of video signals to the panel driving unit 12, liquid crystal of the panel 14 is controlled according to the processed video signals, and then the panel 14 displays pictures corresponding to the processed a plurality of video signals.

In general, a plurality of areas are divided from the back light module 13. After the timing control unit 11 receives the plurality of video signals, the plurality of video signals are classified into a plurality of groups. Then, an average brightness of each group of the plurality of video signals is calculated. The average brightness herein can be represented by a voltage value or a numeric value. Furthermore, a luminescence gamma voltage corresponding to the average brightness of the group of the plurality of video signals is selected. In the present embodiment, a plurality of values are predetermined, and they correspond to the plurality of areas on the back light module 13. One of the plurality of predetermined values, which is close to the average brightness of the group of the plurality of video signals, is selected to serve as the luminescence gamma voltage.

In accordance with each group of the luminescence gamma voltage, a plurality of scanning signals are transmitted to the scanning driver 133, and a plurality of video signals are transmitted to the data driver 134. On the cathode plate 135 of the back light module 13, the plurality of electron emitters 139 corresponding to an area of the plurality of video signals are driven to produce a voltage reaching to the luminescence gamma voltage by the scanning driver 133 and the data driver 134.

In the present embodiment, the quantity of electrons emitted by the plurality of electron emitters 139 is controlled by the plurality of scanning signals which serve as a switch voltage. Energy carried by electrons emitted from the plurality of electron emitters 139 is controlled by the plurality of video signals which serve as a luminescence gamma voltage. The emitted electrons are accelerated toward the anode plate 136 through an electric field between the anode plate 136 and cathode plate 135. Finally, the electrons bombard and stop on the fluorescent substrate 137 coated on the anode plate 136, and then the fluorescent substrate 137 luminesces.

Therefore, when the plurality of electron emitters 139 on the cathode plate 135 of the back light module 13 corresponding to the area of the plurality of video signals are driven to produce the voltage reaching to the luminescence gamma voltage by the scanning driver 133 and the data driver 134, the luminescence of the fluorescent substrate on the area of the plurality of video signals is controlled by the corresponding average brightness of the panel 14.

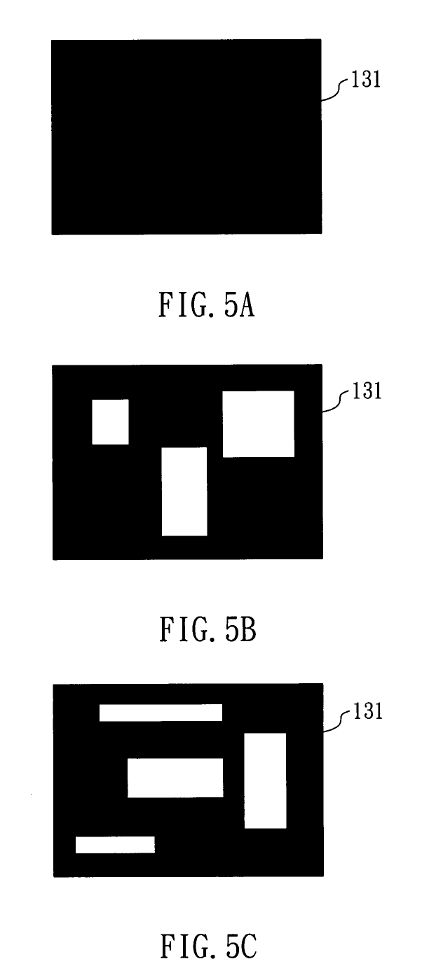

With reference to FIG. 5A, FIG. 5B, and FIG. 5C, there are views of the emitting condition of the field emitting back light plate in the embodiment. In those figures, the white areas and the black areas individually represent luminescence and non-luminescence of the field emitting back light plate 131. Therefore, in the present embodiment, the field emitting back light plate 131 can emit different brightness of light according to the video signals in various timings. In other words, the field emitting back light plate 131 is not necessary to be lit all the time. Hence, in the field emitting back light plate 131, the power consumption is decreased, the life-span is lengthened, and the brightness and the contrast of the whole display picture are increased.

In conclusion, in the present invention, the field emitting back light plate is used as the back light module of the passive light-emitting display device. According to the video signals of the various timings, the field emitting back light plate supplies the regional and the different brightness of light, so as to decrease the power consumption of the light, to lengthen the life-span of the light, and to increase the brightness and the contrast of the whole display picture.

Although the present invention has been explained in relation to its preferred embodiment, it is to be understood that many other possible modifications and variations can be made without departing from the scope of the invention as hereinafter claimed.

What is claimed is:

1. A back light module, which is provided with operating power by a power supply and overlaps a passive light-emitting panel, comprising:
a field emitting back light plate comprising an anode plate, a cathode plate, and a fluorescent substance, wherein the anode plate is located over the cathode plate, and the fluorescent substance is formed on the anode plate; and
a back light driving unit, which conducts to the field emitting back light plate, receives a plurality of video signals, and controls the emission of the field emitting back light plate according to the plurality of video signals, in order to make at least one area of the fluorescent substance luminesce and at least one another area of the fluorescent substance not luminesce.

2. The back light module as claimed in claim 1, wherein the anode plate and the cathode plate enclose a vacuum.

3. The back light module as claimed in claim 1, wherein the cathode plate comprises a plurality of electron emitters thereon.

4. The back light module as claimed in claim 3, wherein the plurality of electron emitters are a plurality of carbon nanotubes.

5. The back light module as claimed in claim 3, wherein the back light driving unit drives the plurality of electron emitters to emit at least one electron toward the anode plate, and at least one area of the fluorescent substance on the anode plate bombarded by the electron emits light.

6. The back light module as claimed in claim 1, wherein the back light driving unit comprises at least one scanning driver and at least one data driver, wherein the scanning driver and the data driver both conduct to the field emitting back light plate.

7. A passive light-emitting display device, comprising:
a timing control unit, which receives a plurality of video signals;
a panel, which displays a picture;
a panel driving unit, which conducts to the timing control unit and the panel; and
a back light module, which overlaps the panel, comprising: a field emitting back light plate, which comprises an anode plate, a cathode plate, and a fluorescent substance, wherein the anode plate is located on the cathode plate and the fluorescent substance is formed on the anode plate; and a back light driving unit, which conducts to the timing control unit and the field emitting back light plate, and controls the emission of the field emitting back light plate according to video signals in order to make at least one area of the fluorescent substance luminesce and at least one another area of the fluorescent substance not luminesce.

8. The passive light-emitting display device as claimed in claim 7, wherein the anode plate and the cathode plate enclose a vacuum.

9. The passive light-emitting display device as claimed in claim 7, wherein the cathode plate comprises a plurality of electron emitters thereon.

10. The passive light-emitting display device as claimed in claim 9, wherein the plurality of electron emitters are a plurality of carbon nanotubes.

11. The passive light-emitting display device as claimed in claim 9, wherein the back light driving unit drives the plurality of electron emitters to emit at least one electron toward the anode plate, and at least one area of the fluorescent substance on the anode plate bombarded by the electron emits light.

12. The passive light-emitting display device as claimed in claim 7, wherein the back light driving unit comprises at least one scanning driver and at least one data driver, wherein the scanning driver and the data driver both conduct to the field emitting back light plate.

13. The passive light-emitting display device as claimed in claim 12, wherein the timing control unit transmits a plurality of scanning signals to the scanning driver, and transmits a plurality of video signals to the data driver.

14. The passive light-emitting display device as claimed in claim 7, wherein the panel is non-luminous.

15. The passive light-emitting display device as claimed in claim 7, wherein the panel is a liquid crystal panel.

16. The passive light-emitting display device as claimed in claim 7, wherein the panel driving unit comprises at least one gate driver, and at least one source driver, and the gate driver and the source driver conduct to the timing control unit and the display unit.

17. The passive light-emitting display device as claimed in claim 7, further comprising a power supply, which conducts to the timing control unit, the panel driving unit, the back light driving unit, and the back light module, in order to provide operating power to them.

18. A method for driving a back light in order to control a back light module of a passive light-emitting display device, comprising the following steps:
receiving a plurality of video signals;
classifying the plurality of video signals into a plurality of groups, and each of the plurality of groups corresponding to each of the plurality of areas on the back light module;
calculating an average brightness of each group of the plurality of video signals;
selecting a luminescence gamma voltage corresponding to the average brightness of each group of the plurality of video signals; and
driving each area of the back light module corresponding to each group of the plurality of video signals according to the luminescence gamma voltage.

19. The method as claimed in claim 18, wherein the luminescence gamma voltage corresponding to each group of the plurality of video signals is selected from one of the plurality of predetermined values.

20. The method as claimed in claim 18, wherein the plurality of video signals are input into a timing control unit, and the timing control unit outputs the plurality of video signals to a panel.

21. The method as claimed in claim 18, wherein each area of the back light module corresponding to each group of the plurality of video signals is close to each other.

22. The method as claimed in claim 18, wherein the plurality of predetermined values of the luminescence gamma voltages are utilized to drive the corresponding areas of the back light module to emit different light brightness.
